(19) United States
(12) Patent Application Publication
(10) Pub. No.: US 2011/0192743 A1
(43) Pub. Date: Aug. 11, 2011

(54) Shock Absorber For Portable Devices

(76) Inventors: Derek M. May, Los Angeles, CA (US); Lee A. Doerr, III, Venice, CA (US)

(21) Appl. No.: 13/023,284

(22) Filed: Feb. 8, 2011

Related U.S. Application Data
(60) Provisional application No. 61/337,768, filed on Feb. 8, 2010.

(51) Int. Cl. B65D 85/00; B23P 19/04

(52) U.S. Cl. 206/320; 29/428

(57) ABSTRACT

A shock absorber assembly for protecting a portable electronic device includes a number of protective elements disposed about the periphery of the portable electronic device. The protective elements are coupled to one another by an adjustable tension cord received through a passage in each of the protective elements. The adjustable tension cord is engaged with a fastener that is configured to be positioned in a secured position in which the tension of the adjustable tension cord is not adjustable and an adjustable position in which the tension of the adjustable tension cord may be adjusted by the user by moving the fastener with respect to the adjustable tension cord. The protective assembly is configured to protect the device from shocks and to elevate the device above a support surface to protect it from contact with moisture on the support surface.

### CROSS-REFERENCE TO RELATED APPLICATIONS

The present application claims priority to U.S. Provisional Patent Application No. 61/337,768 to May and Doerr III, filed on Feb. 8, 2010 and entitled “Shock Absorber for Portable Devices,” the entire disclosure of which is hereby incorporated by reference.

### BACKGROUND OF THE INVENTION

The present invention relates to portable electronic devices such as tablet computers, smart phones, laptops, and the like. More particularly, the present invention relates to assemblies configured to protect portable electronic devices from accidental damage caused by, for example, drops, unclean surfaces, spills, and the like.

There are numerous known tablet-style computers and other portable electronic devices including, for example, personal digital assistants (PDAs), laptop computers, smart phones, mobile phones, satellite phones, cellular phones, pagers, music players, MP3 players, digital media players, digital cameras, video cameras, projectors, flat screen TVs, bar code scanners, global positioning systems (GPS), and portable video game consoles, and other portable or non-portable electronic devices. These known devices are used by an increasingly large number of people in a wide variety of activities and throughout the entirety of their day-to-day lives. Typically, during use or storage, the portable devices are placed on relatively flat horizontal surfaces such as tables, desks, trays, and other such surfaces.

These devices may suffer damage if the device is dropped, falls, or is otherwise subjected to an abrupt physical shock because such shocks are completely absorbed by the device. Further, devices of this type are susceptible to being damaged from spills or from being put into contact with foreign substances. As these causes are quite common and often the result of operator negligence, such damage is typically not covered by product warranties thereby requiring the operator to purchase a replacement device at considerable cost or to go without use of the device altogether. Moreover, damage to the device may result in the loss of personal and/or work data of great importance and value such as, e.g. phone numbers, financial information, documents, digital photographs, videos and music, etc.

Accordingly, it is becoming increasingly common for users of such portable electronic devices to utilize protectors such as cases designed to prevent the device from being damaged when subjected to shocks and/or contamination by liquids and other harmful substances. Such protectors typically employ a thin layer of material such as plastic, rubber, leather, and the like to encase at least a portion of the device. These protectors typically cover the device's buttons, adapter ports, and display. Most commonly, such protectors cover the entirety of the device such as when the device is not in use.

These known protectors suffer from a number of disadvantages. For one, these protectors fail to reinforce the corners of the device, which are understandably most susceptible to damage upon experiencing a shock to the device. In addition, these protectors fail to substantially elevate the device so as to avoid damage from spilled liquids or other undesirable substances that may be introduced into the area surrounding the device. That is, known protectors tend to provide only a very minimal amount of material around the device so as to provide a relatively low profile, and this hampers protectors of this type from protecting against spills as the device remains relatively close to the support surface.

Yet another disadvantage of known protectors is that they are often device specific and unable to accommodate more than one device. Because it is common for users to own more than one portable electronic device, it can be rather costly to provide protectors for each of the portable electronic devices.

Depending on material characteristics, many known protectors additionally stretch out over time such that the protector is less snugly secured around the device over time. Further, known protectors tend to fade, which makes them less aesthetically pleasing as the protector ages, requiring the purchase of a new protector. Finally, another disadvantage of protectors of this type is that they are often not configured to support the device in more than one orientation. Thus, the user of the device is constrained to using the device in a single orientation despite the fact that many known devices allow a user to operate the device in multiple orientations. In the alternative, the user may rearrange the protector when he or she wishes to use the device in an alternative orientation; of course, this can be a rather time consuming and laborious process that further subjects the device to potential unprotected falls and damage.

Accordingly, a protector for a portable electronic device that overcomes one or more of the foregoing disadvantages is desired.

### SUMMARY OF THE INVENTION

The present invention is directed to an assembly for protecting a portable electronic device from accidental damage due to forces imparted upon the device through falls and other such incidences as well as spills or contacts with foreign substances that may be present on a support surface. The assembly includes a number of protective elements. The protective elements include a receiver, which may be defined by a cut-out portion thereof. The receiver of each of the protective elements is configured to selectively receive an edge of the portable electronic device, and in one embodiment may be configured to receive a corner of the device. The protective elements are adapted to be releasably secured to the device, and in one embodiment may be connected to each other in a manner that engages each protective elements with each other and with the device. In one embodiment, each of the protective elements includes a channel formed through the protective element. The channel is configured to receive a flexible elongated connector, such as an adjustable tension cord, which extends through the channels of the protective elements and couples the protective elements to one another and tightens the protective elements onto the device. The adjustable tension cord may include a fastener configured to receive ends of the adjustable tension cord and to allow the user to selectively adjust the tension in the adjustable tension cord by moving the fastener with respect to the adjustable tension cord to either increase or decrease the tension in the adjustable tension cord.

Thus, in operation, a user of the assembly may couple each of the protective elements to the device, e.g. such that a protective element is located one at each of the corners of the device, and arrange the adjustable tension cord such that it is strung through the channels and along an outside perimeter of the device. Once the protective elements are coupled to each of the corners, the user may actuate a tension adjusting element of the fastener to thereby tighten the assembly to the device. To remove the assembly from the device, the user simply releases the tension in the adjustable tension cord by actuating the tension adjusting element and moving the fastener along the adjustable tension cord. Once the tension in the adjustable tension cord has been sufficiently reduced, the protective elements may be removed from engagement with the device.

Thus, in use, the user may rest the device on the protective elements on a support surface so that the device remains at least partially elevated above the support surface so as to avoid accidental damage from spills or from contacting foreign substances that may be on the support surface. Moreover, the protective elements are configured such that if the device should be accidentally dropped or otherwise fall from a height, the protective elements substantially absorb the shock so that the device is not damaged by the fall.

Various other features, objects and advantages of the present invention will be made apparent from the following detailed description and the drawings.

### BRIEF DESCRIPTION OF THE DRAWINGS

The drawings illustrate a representative embodiment presently contemplated for carrying out the invention.

In the drawings:

FIG. 1 is an isometric view of an exemplary portable device with protective elements according to the present invention coupled to corners thereof;

FIG. 2 is an isometric view of one of the protective elements of the present invention;

FIG. 3 is a side elevation view of the protective element of FIG. 2;

FIG. 4 is a top plan view of a protective element of FIG. 2;

FIG. 5 is a side elevation view of the portable device of FIG. 1 supported by the protective elements on a support surface;

FIG. 6 is a partial isometric view of two protective elements coupled to one another by way of an adjustable tension cord of the present invention;

FIG. 7 is an exploded view of a representative fastener of the present invention;

FIG. 8 is an isometric view of an alternative configuration of the protective elements coupled to the portable device;

FIG. 9 is an isometric view of yet another alternative configuration of the protective elements coupled to the portable device;

FIG. 10 is a front elevation view of another configuration of the protective elements wherein the adjustable tension cord may be used as a support for hanging the portable device;

FIG. 11 is an isometric view of yet another configuration of the protective elements coupled to the portable device in which the adjustable tension cord is partially concealed behind the portable device;

FIG. 12 is an isometric view of yet another configuration of the protective elements coupled to a portable device; and

FIG. 13 is an isometric view of the present invention as shown in FIG. 12 and showing a front panel partially removed from a face thereof.

### DETAILED DESCRIPTION OF PREFERRED EMBODIMENTS

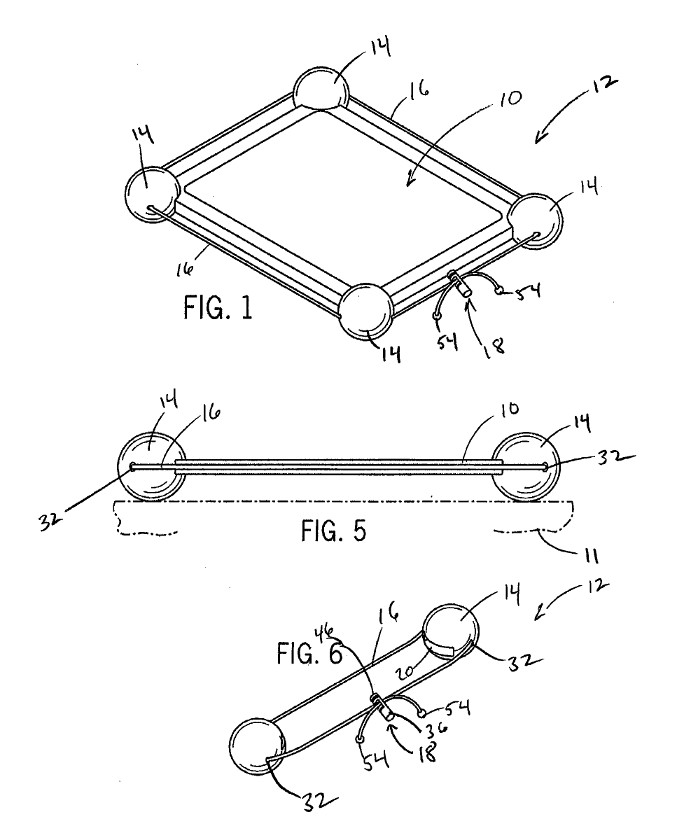

Referring now to the drawings and initially to FIG. 1, a portable electronic device 10 is shown with a protective assembly 12 according to the present invention coupled thereto. As illustrated, device 10 is shown as a tablet-style computer; however, device 10 may be any portable electronic device known in the art including, but not limited to, personal digital assistants (PDAs), laptop computers, smart phones, mobile phones, satellite phones, cellular phones, pagers, music players, MP3 players, digital media players, digital cameras, video cameras, bar code scanners, global positioning systems (GPS), portable video game consoles, flat screen TVs, bar code scanners and other portable or non-portable electronic devices. In addition, while device 10 is shown as having a rectangular shape, it is understood that device 10 may be configured in any number of alternative configurations including square, triangular, or any other polygonal shape. Further, device 10 may be entirely devoid of corners and may have a circular, oval, or other such rounded shape.

Protective assembly 12 includes a number of protective elements 14 coupled to the device 10, such as at the corners of device 10. Protective elements 14 may be constructed from any number of materials capable of supporting device 10 in a substantially sturdy manner while being substantially shock absorbing so that in the case device 10 is dropped, the shock experienced by device 10 is minimal. For instance, protective elements 14 may be constructed from a foam or a resilient plastic material. Protective elements 14 have a thickness greater than that of device 10 such that, when each protective element is engaged with device 10, a portion of the protective element extends above the upper surface of device 10 and a portion of the protective element extends below the lower surface of device 10. As illustrated, device 10 is supported by four protective elements 14, but it is understood that device 10 may include one or more additional protective elements 14 or alternatively may include between one and three protective elements 14 as will be discussed herein. Further, while protective elements 14 are shown positioned at the corners of device 10, the protective assembly 12 of the present invention is not limited to such constructions as will be discussed further herein. Further, while protective elements 14 are illustrated as being substantially spherical, it is understood that elements 14 may have any number of different shapes in keeping with the spirit of the present invention. In addition, while protective elements 14 preferably have a certain degree of resilience to provide a cushioning effect, it is understood that the elements 14 may be formed of a rigid material if it is desired simply to support and elevate the device 10 without providing a cushion feature.

The protective elements 14 of the present invention are secured in place on the device 10 in any satisfactory manner. In one embodiment, the protective elements 14 are engaged with the device 10 by securing the protective elements to one another. In this regard, the protective elements 14 may be secured together and onto device 10 by way of an adjustable tension cord 16 that is received through each of the elements 14 to thereby secure each of the elements 14 to the other of the elements 14. Adjustable tension cord 16 may be constructed from any suitable material and may or may not be relatively elastic, and in any event ensures that regardless of the distance between the protective elements 14, the protective assembly 12 remains snugly secured to device 10. A fastener 18 may be provided for receiving adjustable tension cord 16 and for adjusting a tension thereof. In at least one construction of the present invention, fastener 18 may be a buckle assembly configured to adjust the tension of adjustable tension cord 16. Of course, fastener 18 may take on the form of any suitable means for adjusting the tension of the adjustable tension cord 16.

Referring to FIG. 5, device 10 is shown with a number of protective elements 14 coupled to the corners thereof to thereby support device 10 on a support surface 11. As can be clearly seen, the device 10 is supported a significant distance off of the support surface 11. In this manner, the device 10 is elevated above any potential spills or other harmful substances that may be on support surface 11 to prevent damage to device 10. In addition, the elevation of device 10 above the surface 11 provides air circulation below device 10 for cooling purposes. Protective elements 14 also cushion the device 10 and provide clearance above the support surface 11 in the event an object is dropped or set on the device 10 as it is supported on the support surface.

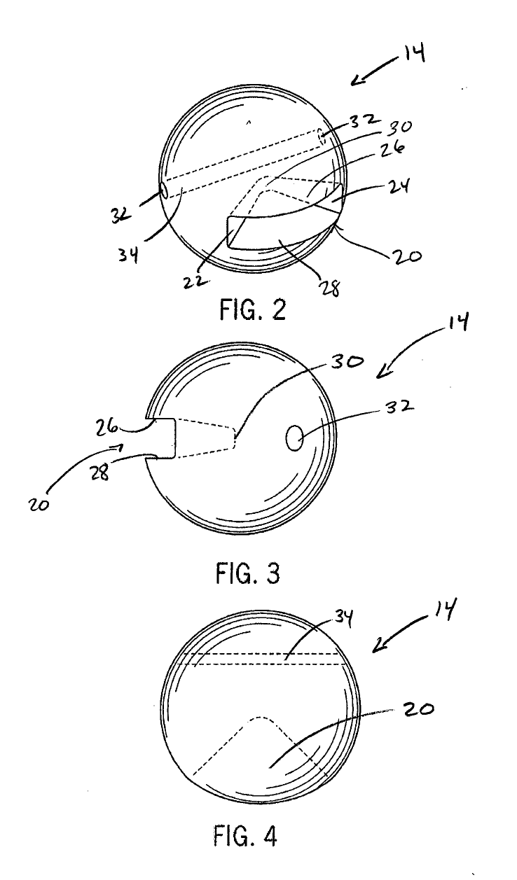

Referring now to FIGS. 2-4, an exemplary construction of protective elements 14 is shown. As noted previously, protective elements 14 may have any construction suitable for carrying out the present invention, and as shown, protective elements 14 may be generally spherical in shape. Protective elements 14 include a receiver 20. In particular, receiver 20, as illustrated, may be in the form of a generally elongate aperture extending along a surface of the protective element 14 and configured to receive a portion of device 10 therein, which may representatively be a corner of the device 10. The aperture defining receiver 20 extends inwardly from the surface of protective element 14 toward a center of protective element 14 and is defined by a pair of side walls 22, 24, an upper wall 26 and a lower wall 28. Side walls 22, 24 extend inward from the elongate aperture toward a center of protective element 14. An upper edge and lower edge of the side walls 22, 24 may have a gradual slope that terminates in an edge 30 configured to abut up against a portion of the device 10 to secure the device 10 to the protective element 14. In one construction of receiver 20, side walls 22, 24 do not have a slope but rather are simply extend generally straight toward edge 30. Receiver 20 may have a generally triangular cross section or any other such shape so as to accommodate securing element 14 to an edge, such as a corner, of device 10. In one construction of the present invention, receiver 20 may be configured to receive one or more inserts (not shown). The inserts are configured to be inserted into the receiver 20 to thereby provide a user-adjustable receiver 20 such that the receiver 20 may be configured to accommodate a wide variety of device 10 corner thicknesses and shapes.

Protective elements 14 further include a pair of opposing apertures or holes 32, each of which defines the entry of a passage or channel 34 extending through protective element 14 therebetween. Holes 32 and channel 34 may be positioned rearward with respect to and generally aligned with receiver 20, such that channel 34 lies substantially in the same plane as device 10 when protective assembly 12 is secured thereto. It is understood, however, that holes 32 and channel 34 may be in any other desired location, such as above, below or transverse to the plane of the device 10. Holes 32 and channel 34 may be generally sized and shaped to receive adjustable tension cord 16. As can be best appreciated by viewing FIGS. 2 and 4, channel 34 may be generally elongate and relatively straight. Of course, channel 34 may be curved or have some other shape. Channel 34 may have a generally round cross section or may otherwise be shaped to accommodate adjustable tension cord 16. As each of protective elements 14 of protective assembly 12 include holes 32 and channel 34, each of protective elements 14 may therefore be connected with the other of the protective elements 14 of the protective assembly 12 to provide an interconnected protective structure for protecting device 10.

Alternatively, it is understood that the protective elements 14 may be secured to the edges of the device 10 in a manner other than via interconnection using tension cord 16. For example, each protective element 14 may be engaged with the device 10 separately from the other protective elements 14, such as via an individual clamping arrangement provided on each protective element 14 that secures the device 10 to the protective element 14, or by an adhesive or any other satisfactory securing arrangement. In addition, certain of the protective elements may be connected together using a tension cord 16 without engagement with the other of the protective elements 14, or multiple tension cords 14 may be used in a criss-cross pattern to connect opposing protective elements 14 together (as will later be described). Other variations of engaging the protective elements 14 to the device 10 are possible and contemplated within the scope of the present invention.

Referring to FIG. 6, an exemplary configuration of protective assembly 12 removed from device 10 is shown in which protective assembly 12 includes a pair of protective elements 14 interconnected with one another by way of adjustable tension cord 16 received through the corresponding holes 32 of each of the elements 14. Fastener 18 may be configured for adjusting the tension of the adjustable tension cord 16 so that regardless of the size of the device 10 to which the protective assembly 12 is coupled, the protective assembly 12 may securely retain the device 10.

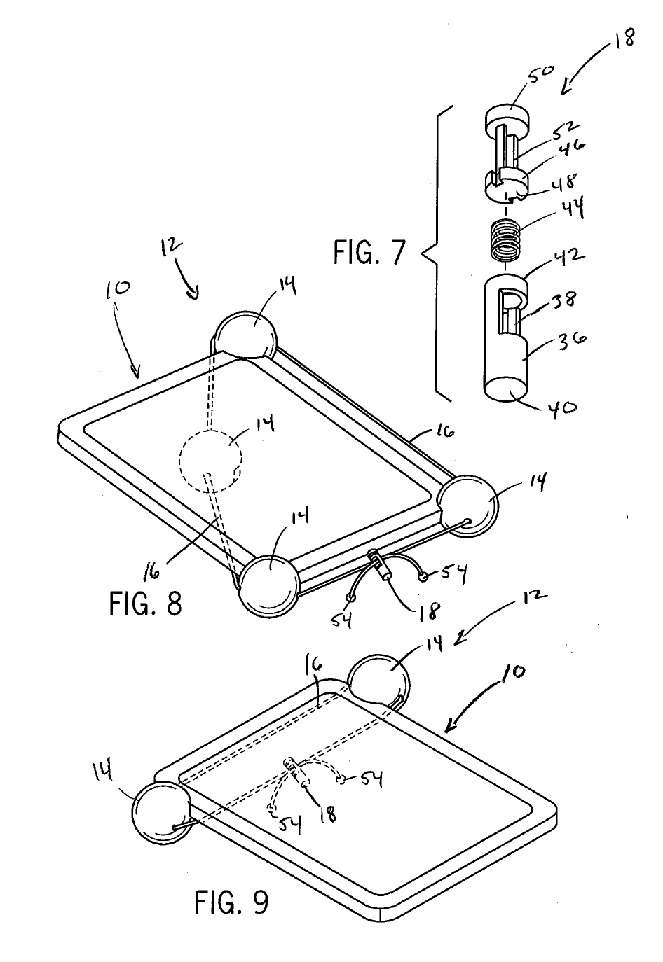

Turning now to FIG. 7, an exemplary construction of fastener 18 is shown. While the following description relates to the construction of fastener 18, it is understood that fastener 18 is simply representative of any number of fasteners or connection devices that may be employed. Fastener 18, as illustrated, includes a casing 36 that may be generally cylindrical in shape and includes an aperture 38 through which ends of adjustable tension cord 16 may be received. Casing 36 includes a closed end 40 and an opposing open end 42. Open end 42 is configured to receive a biasing element 44 such as a spring or similar such element. Open end 42 additionally receives a tension adjusting element 46 around which adjustable tension cord 16 may be wound as will be discussed. Tension adjusting element 46 is movably received within the interior of casing 36. In particular, tension adjusting element 46 is coupled to biasing element 44 at a first end 48 and biasing element 44 is coupled to casing 36 at a second end 50 thereof to thereby couple the tension adjusting element 46 within the cavity defined by casing 36. The second end 50 is opposite first end 48, and is selectively actuatable by the user as will be explained. As such, second end 50 may extend a distance beyond an edge of open end 42 so that it is easily depressible by the user. A body 52 is disposed between the first end 48 and a second end 50 about which adjustable tension cord 16 may be wound or otherwise received. Fastener 18 is constructed so that at rest, biasing element 44 biases the tension adjusting element 46 toward open end 42 of casing 36 such that fastener 18 is in a secured position in which the tension of the adjustable tension cord 16 is not adjustable. That is, when the tension adjusting element 46 is in the secured position, tension adjusting element 46 and casing 36 are configured to pinch or otherwise restrain adjustable tension cord 16 from movement such that the adjustable tension cord 16 is maintained in a certain position. As desired, the user may depress the tension adjusting element 46 to compress the biasing element 44 to position the fastener 18 in the adjustable position. In the adjustable position, the tension adjusting element 46 is moved toward closed end 40 such that tension adjusting element 46 is no longer pinched between casing 36 and tension adjusting element. Accordingly, the tension in the adjustable tension cord 16 may be adjusted by pulling the adjustable tension cord 16 through the fastener 18 to increase the tension or by sliding the fastener along the slack in the adjustable tension cord 16 to thereby increase the slack and reduce the tension.

In one construction of the protective assembly 12, an additional fastener or similar such element such as Velcro fastener (not shown) may be provided for restraining any excess length of the adjustable tension cord 16 so that it remains out of the user's way when device 10 is being used.

In operation, protective assembly 12 is assembled by first threading the adjustable tension cord 16 through the holes 32 in each of the one or more elements 14. Once each of the elements 14 is interconnected by way of adjustable tension cord 16, the ends of adjustable tension cord 16 are passed through fastener 18 while fastener 18 is in an adjustable position. The ends of adjustable tension cord 16 are secured by releasing the fastener 18 such that it returns to its secured position. The ends of adjustable tension cord 16 may be fitted with one or more stopper elements 54 configured to prevent the ends of adjustable tension cord 16 from being pulled through fastener 18.

Once the protective assembly 12 is assembled, it may be secured to the device 10. To accomplish this, each of the elements 14 is slid into engagement with one of the corners of the device 10 such that the corner is completely received within receiver 20 of the respective protective element 14. Once the protective elements 14 are secured to the device 10, the user may adjust the tension of adjustable tension cord 16 to ensure a secure fit to the device 10 by pinching the fastener 18 such that it is again positioned in the adjustable position so that the adjustable tension cord 16 may be cinched or otherwise pulled tightly. In this manner, the elements 14 are securely coupled to the respective corners of device 10. After a desired amount of tension has been applied to the adjustable tension cord 16, the user then releases fastener 18 so that it returns to its secure position. Protective elements 14, tension cord 16 and device 10 thus form an interconnected assembly in which device 10 supports the components of the protective assembly 12, which in turn function to protect device 10 against shocks and spills as noted above.

Fastener 18 may be oriented in any number of ways and may be positioned along any side of device 10. The user may adjust the position of fastener 18 by pinching or otherwise depressing the fastener 18 so that it is in the adjustable position and the tension is released from adjustable tension cord 16. The user may rotate the positions of the elements 14 in any manner desired so that the fastener 18 is oriented as desired.

Referring again to FIG. 5, one configuration of the protective assembly 12 of the present invention is illustrated. As shown, device 10 includes a protective element 14 at each of the four corners of device 10. In this manner, the user of device 10 may place the device 10 on support surface 11 so that the device 10 rests on protective elements 14 and is elevated above the support surface 11 to protect device 10 from spills or substances present on support surface 11. In this configuration, if device 10 should be accidentally dropped or otherwise fall to the ground, device 10 is prevented from striking the ground directly by the presence of protective elements 14. Further, because protective elements 14 are configured to absorb shocks, the shock experienced by the device 10 is substantially limited so that the device 10 is not adversely affected. Protective elements 14 further provide support to device 10 such that the user of device 10 may use the device 10 while it is supported on support surface 11. In particular, protective elements 14 serve to raise device 10 off of support surface 11 to dispose device 10 at an elevated position for the user so that use of the device in a relatively flat orientation is more comfortable. Understandably, protective elements 14 of the present invention may be secured around any number of different devices 10 and therefore can be removed from one device and secured to another as desired. Further, protective elements 14 are configured so that that device 10 may be oriented in any number of alternative configurations. In addition, protective elements 14 enable device 10 to be securely arranged on and secured to any number of surface types including surfaces that are relatively uneven. To that end, protective elements 14 may be configured to prevent sliding with respect to the surface. Further, protective elements 14 may be configured so that the device 10 may be propped up against a wall or other such object.

Turning now to FIGS. 8-13, a number of alternative configurations of protective assembly 12 with device 10 are illustrated. Referring first to FIG. 8, a triangular configuration is illustrated in which protective elements 14 are generally arranged in a triangular manner such that one end of device 10 is elevated with respect to the other end of the device. To arrange the protective elements 14 in this manner, one of the protective elements 14 is removed from one of the corners of device 10 and positioned against the underside of device 10. The position of the protective element 14 may be adjusted by the user as desired so that the device 10 is situated in a desired tilted orientation in which user support is unnecessary. Once element 14 is situated as desired, adjustable tension cord 16 may be tightened as previously discussed to ensure that protective assembly 12 is securely coupled to device 10.

Now referring to FIG. 9, another arrangement of protective elements 14 is illustrated. In this arrangement, protective assembly 12 includes a pair of protective elements 14, protective elements 14 may be arranged at the corners of any one side of device 10 to thereby provide a support for device 10 having a gradual slope such that a distal end of device 10 is elevated with respect to a proximal end. Of course, either end of device may be positioned proximate the user of the device 10 as desired. As illustrated, protective elements 14 are shown secured to the sides of device 10 as opposed to the corners while the adjustable tension cord 16 is secured behind device 10. Understandably, protective elements 14 may be provided at the corners as in the previous configurations and the adjustable tension cord 16 may be arranged along the perimeter of the device 10 as before. As previously discussed, adjustable tension cord 16 may be tightened as necessary using fastener 18 to provide the necessary security for the device 10. Further, in one construction of protective assembly 12 as shown in FIG. 9, one or more additional protective elements 14 may be provided; however, as desired, the user may simply remove the protective elements 14 and position them to the side while the device 10 is arranged as illustrated. In this manner, the user may orient the device 10 in a desired manner while in use and supported on the support surface 11, and then once the user has finished using device 10 or wishes to transport it to another location, the user may reattach the protective elements 14.

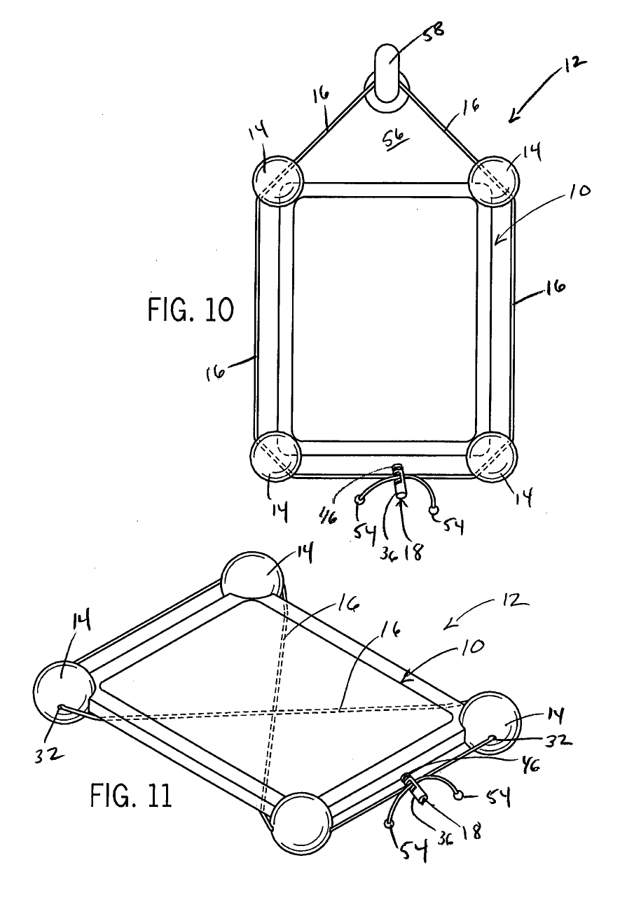

Turning to FIG. 10, another construction of the protective assembly 12 of the present invention is illustrated. As shown, four protective elements 14 are provided so that one protective element 14 is located at each of the corners of device 10. With this arrangement, device 10 may be hung on a wall or similar surface 56 by way of adjustable tension cord 16 being received through a hook or hanger element 58. In addition, tension cord 16 may be used to secure the device to the back of a car seat, steering wheel, or any other object or surface as desired. In this manner, device 10 may be supported without aid of the user of device 10 such that it may be used as a digital picture frame, video and/or audio source, or the like. Further, protective elements 14 prevent the device 10 from contacting the surface 56 directly to thereby protect the surface 56 from being scratched and additionally to protect the device 10 from being scratched or damaged. While device 10 is shown in a portrait orientation, it is understood that device 10 may also be hung in a landscape orientation.

Much like shown in FIG. 10, adjustable tension cord 16 may be used as a handle for carrying the device 10. In particular, the user of device 10 may simply grasp the adjustable tension cord 16 for carrying the device 10 from place to place. In this manner, device 10 is further protected from damage or from becoming dirtied by substances that may be on the user's hands, for example. Adjustable tension cord 16 may be grasped about any length thereof for serving as a handle. Moreover, the adjustable tension cord 16 may be used as a handle to accommodate a user playing a game on the device 10 in which the game utilizes motion control technology. In this manner, the user is able to maintain control of the device 10 while being assured that should the device 10 fall, it will be protected from damage.

Referring now to FIG. 11, yet another construction of protective assembly 12 is illustrated. In this construction, four protective elements 14 are positioned such that a protective element 14 is located one at each of the four respective corners of device 10. In this instance, rather than provide adjustable tension cord 16 about the entire perimeter of device 10, much of the adjustable tension cord 16 is disposed behind the device 10 in a crossing fashion. In this manner, adjustable tension cord 16 is hidden behind device 10 so as to be less visible, which may be desired in certain uses of device 10 or according to user preference.

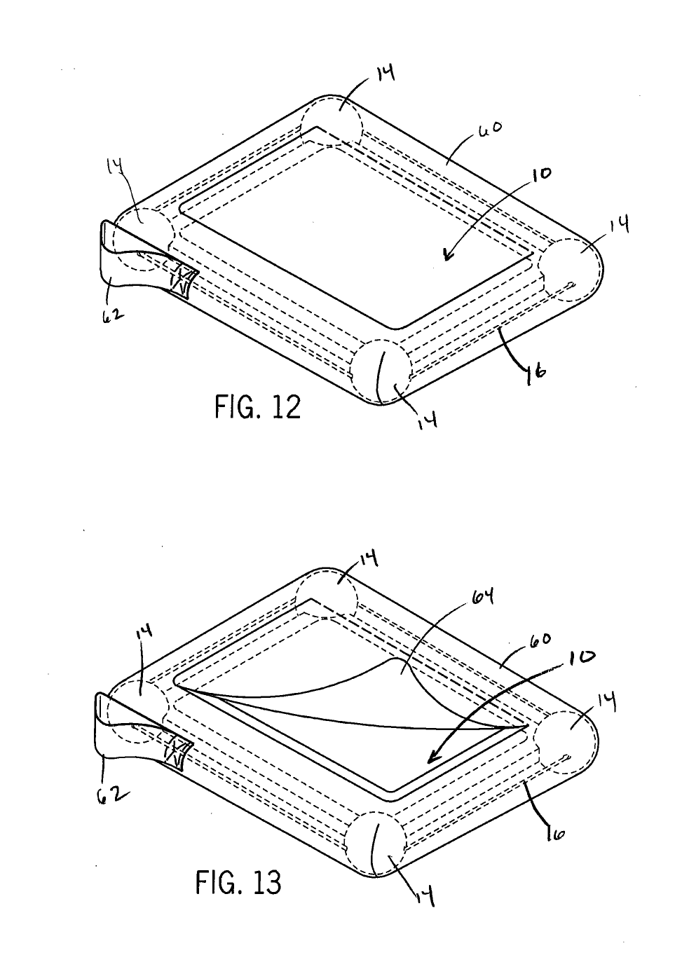

Now turning to FIGS. 12-13, another construction of protective assembly 12 is illustrated. In this embodiment, protective assembly 12 further includes a sleeve 60 that is receivable over device 10 and protective elements 14. Sleeve 60 may be constructed of any satisfactory material and is generally configured to be received over the device 10 and in particular is configured to be received over the protective elements 14 when engaged with the device 10. As such, sleeve 60 may include relatively larger areas around the corners to thereby accommodate the presence of protective elements 14. In this manner, sleeve 60 further provides protection for device 10 and in particular the display element of the device 10. Sleeve 60 may include a handle 62 or other means for carrying device 10 while it is stored in the sleeve 60. Handle 62 may be provided anywhere along the entirety of sleeve 60 and may be selectively stowable within the sleeve 60. Handle 62 may be constructed from the same or similar material as sleeve 60. One or more additional handles may be provided on sleeve 60 as desired.

Referring now to FIG. 13 in particular, sleeve 60 may further include a cover 64 that is configured to selectively cover the display of the device 10. Cover 64 may include means for enabling it to be removed or otherwise peeled away from the display of device 10 such that device 10 may be used while housed within sleeve 60. For instance, cover 64 may include a zipper configured to cooperate with a zipper on the sleeve 60 such that it may be zipped and unzipped as desired. Similarly, Velcro or a similar such attachment means may be used.

In another construction of sleeve 60 according to the present invention, sleeve 60 may be configured to encase or otherwise securely receive the device 10 while the device 10 is enclosed in a standard protective case. In this construction, device 10 is secured within a standard protective case of the kind generally known in the art. The protective elements 14 are then secured to the corners of the standard protective case and the sleeve 60 secured over the protective elements 14 and standard protective case.

The present invention has been described in terms of a representative embodiment, and it is recognized that equivalents, alternatives, and modifications, aside from those expressly stated, are possible and within the scope of the appending claims.

What is claimed is:

1. A protective assembly for protecting an electronic device, the protective assembly comprising:
a plurality of protective elements adapted to be secured to the electronic device, wherein each protective element has a thickness greater than a thickness of the electronic device; and
an elongated engagement member engaged with each of the plurality of protective elements to secure the plurality of protective elements to one another and onto the electronic device.

2. The protective assembly of claim 1, wherein the plurality of protective elements are secured to corners of the electronic device and are configured to elevate at least a portion of the electronic device above a support surface.

3. The protective assembly of claim 1, wherein each of the plurality of protective elements includes a receiver formed therein and configured to matingly receive a corner of the electronic device.

4. The protective assembly of claim 1, wherein the elongated engagement member comprises an adjustable tension cord, and further comprising a fastener through which the adjustable tension cord is received, and wherein the fastener is configured to adjust tension in the adjustable tension cord.

5. The protective assembly of claim 4, wherein the fastener includes a casing for receiving a biasing element and a tension adjusting element.

6. The protective assembly of claim 5, wherein the fastener is selectively positionable in an adjustable position in which the tension adjusting element compresses the biasing element and the adjustable tension cord is freely movable with respect to the fastener for adjusting the tension in the adjustable tension cord.

7. The protective assembly of claim 6, wherein the biasing element is configured to position the tension adjusting element in a fixed position on the adjustable tension cord whereby the tension adjusting element and casing impart a force on the adjustable tension cord to thereby prevent adjusting of the tension of the adjustable tension cord.

8. The protective assembly of claim 1, wherein the plurality of protective elements are spherically shaped.

9. The protective assembly of claim 1, wherein each protective element includes a pair of apertures and a channel extending between the apertures for receiving the elongated engagement member therethrough.

10. A method of protecting an electronic device comprising the steps of:
providing a plurality of protective elements, each of which has a thickness greater than a thickness of the electronic device and includes a recess configured to receive a portion of the electronic device; and
securing the protective elements to the electronic device at spaced locations about the periphery of the electronic device such that a portion of the electronic device is engaged within the recess of each protective element, wherein, when the protective elements are secured to the electronic device, a portion of each protective element extends above an upper surface of the electronic device and a portion of each protective element extends below a lower surface defined by the electronic device.

11. The method of claim 10, each protective element includes a pair of holes and a passage extending therebetween, and further comprising the steps of threading an elongated engagement member through the passage of each protective element to couple the plurality of protective elements to one another, and securing the plurality of protective elements to the electronic device by tightening the elongated engagement member and urging the protective elements onto the electronic device.

12. The method of claim 11, wherein the step of tightening the elongated engagement member is carried out by inserting ends of the elongated engagement member through a fastener having a casing secured around a biasing element and receiving a tension adjusting element that is biased by the biasing element to a secured position and selectively depressible to position the tension adjusting element in an adjustable position, wherein the fastener is configured to enable a user to adjust the tension of the elongated engagement member.

13. The method of claim 11, further comprising the steps of releasing the elongated engagement member and removing the plurality of protective elements from the electronic device.

14. The method for claim 10, further comprising the step of hanging the electronic device by the elongated engagement member.

15. The method of claim 10, further comprising the step of securing the electronic device in a sleeve configured for transporting the electronic device while the plurality of protective elements are coupled thereto.

16. A kit for use in protecting an electronic device comprising:
a plurality of protective elements configured to be secured to edge areas defined by the electronic device;
an elongated engagement member coupled to the plurality of protective elements; and
a fastener secured to the elongated engagement member and configured to retain the elongated engagement member and the protective elements on the electronic device.

17. The kit of claim 16, wherein the fastener includes a casing housing a biasing element and a tension adjusting element that is selectively engageable with the biasing element to position the fastener in an adjustable position.

18. The kit of claim 16, wherein the fastener is configured to adjust tension in the elongated engagement member ord.

19. The kit of claim 16, wherein the plurality of protective elements are generally spherical in shape.

20. The kit of claim 16, further comprising a sleeve configured to be received over the electronic device while the plurality of protective elements are coupled to the electronic device.
